(19) United States
(12) Patent Application Publication
(10) Pub. No.: US 2005/0069800 A1
(43) Pub. Date: Mar. 31, 2005

(54) Colored magnetically attractable toner powder

(76) Inventors: Marcella Coppenrath, Meijel (NL); Marcel D. Everaars, Grashoek (NL); Paul J.G. Ickenroth, Swalmen (NL); Huberdina P.M. Smits, Leunen (NL)

Correspondence Address: BIRCH STEWART KOLASCH & BIRCH, PO BOX 747, FALLS CHURCH, VA, 22040-0747, US

(21) Appl. No.: 10/940,621

(22) Filed: Sep. 15, 2004

(30) Foreign Application Priority Data
Sep. 30, 2003 (NL) 1024415

(51) Int. Cl. G03G 9/09

(52) U.S. Cl. 430/108.21

(57) ABSTRACT

A colored magnetically attractable toner powder containing magnetically attractable material and a coloring substance containing at least one thermoplastic resin and, as coloring constituent a mixture of fluorescent dyes, at least one dye being of the formula 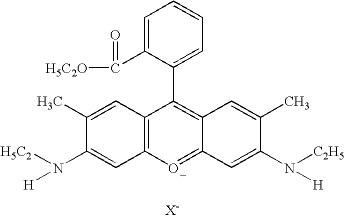
wherein X is an anion, such as, for example, tetrafluoroborate, boron fluoride, perchlorate, hexafluorozirconate or ethyl sulphate. The dye is preferably used in combination with a fluorescent dye of the type C.I. Basic Violet 1 1:1 (C.I. 45174) and possibly yellow-fluorescent dye. Improved magenta and red toner powders are obtained in this manner.

This non-provisional application claims priority under 35 U.S.C. § 119(a) on Patent Application No. 1024415 filed in The Netherlands on Sep. 30, 2003, which is herein incorporated by reference.

### BACKGROUND OF THE INVENTION

The present invention relates to colored magnetically attractable toner powder of the type described in European Patent Specification No. 0 350 099. This type of toner powder is specifically adapted for use in an electro(photo)graphic printing or copying machine, as described, inter alia, in U.S. Pat. No. 4,860,035 and European Patent 0 373 704.

The toner powder described in European Patent 0 350 099 contains magnetically attractable material enclosed by or dispersed in a coloring substance which contains a thermoplastic resin and coloring material, with fluorescent dye, particularly yellow fluorescent dye, being present as the coloring material. Although according to this patent specification it is possible to obtain toner powders with a reasonably good color quality, a full color printing system, in particular, requires improved toner powders in the colors red and magenta. There is particularly a need for red toner powder having a much higher chroma, hence higher color saturation, than the red toner powders described in the above patent specification or that can be obtained with the combinations of yellow and red or magenta fluorescent dye described therein.

### SUMMARY OF THE INVENTION

The present invention relates to colored magnetically attractable toner powder, the separate particles of which includes magnetically attractable material enclosed by a coloring substance, or finely divided therein, wherein the coloring substance contains thermoplastic resin and coloring material in which the coloring material contains a mixture of fluorescent dyes, at least one of the fluorescent dyes in said mixture being a dye of the formula I:
Formula I 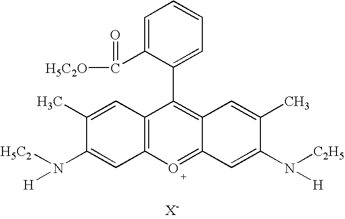
Dyes of this formula are known per se under Color Index No. C1 Pigment Red 81:1.

Using a dye according to the above formula I, it is possible to obtain red and magenta colored toner powders with a considerably higher color saturation than the toner powders that could be obtained heretofore using red or magenta colored dyes as mentioned in European Patent Specification 0 350 099. Like the dye C1 Basic Violet 1 1:1 (Basonyl Rot 550), the dyes according to the above formula are fluorescent.

To manufacture a red toner powder, the dye according to the above formula is combined with one or more highly yellow fluorescing dyes, as described in the above-mentioned European Patent 0 350 099. Furthermore, in order to obtain the correct color shade, one or more other red dyes can be added in addition to red dye of the above formula. Apart from improved red and magenta colored toner powders, considerably improved yellow toner powders can also be obtained according to the present invention, by adding to the coloring substance not only yellow fluorescent dye but also a small quantity of the dye according to the above formula I. The toner powders according to the present invention can be prepared in a known manner by dissolving coloring material in the thermoplastic resin or mixture of thermoplastic resins or by dividing the same Very finely therein, and also including the magnetically attractable material therein in a finely divided state. After cooling to a solid mass, the solid mass is then processed by milling and screening to form a toner powder having the required particle size which, for example, is between 9 and 14 micrometers. To make the toner powder particles suitable for use in an electrographic printing process as described in U.S. Pat. No. 4,860,035, they are also made electrically conductive, for example by depositing on their surface a thin colorless electrically conductive layer. This layer can, for example, consist of fluorine-doped tin oxide and be deposited on the toner powder particles in the manner described in U.S. Pat. No. 5,202,211.

The raw materials for the toner powder according to the invention may be the same as described in European Patent 0 350 099.

A suitable magnetically attractable powder is carbonyl iron having an average particle size of about 3 micrometers.

The thermoplastic resin or mixture of thermoplastic resins is so selected that the fluorescent dyes used, particularly yellow and red or magenta fluorescent dyes, exhibit a high fluorescence therein. Suibtale combinations of the thermoplastic resin and (yellow) fluorescent dye can be determined in the manner described in European Patent No. 0350099. Suitable thermoplastic resins are epoxy resins, polyester resins and modified polyester resins which in their polymer chain bear groups with a dipole moment greater than 2, such as sulphanyl, amide, anhydride or ureide groups. Suitable epoxy resins are relatively low molecular epoxy resins such as those obtainable under the trade names Epikote 1001 and 1004 (Shell-Nederland). Also usable are the resins derived from such epoxy resins and obtained by blocking the epoxy groups with a monofunctional reagent such as p-cumyl phenol, or blocking them to a large extent with a monofunctional reagent and otherwise cross-linking them by intermolecular reaction arid/or reaction with a polyfunctional epoxy hardener. Suitable thermoplastic resins derived from epoxy resins are described, for example, in UK Patent Specifications 2007382, 2014325 and 203653. These resins are regarded as epoxy resins in the context of the invention. Applicable polyester resins are linear resins derived from a dicarboxylic acid and a diol, and also branched polyester resins obtained by polymerization of a dicarboxylic acid with a mixture of a diol with a small quantity, for example 5 mol-%, of a more than bivalent alcohol or by polymerization of a diol with a mixture of a dicarboxylic acid and a small quantity of a more than bivalent carboxylic acid. Suitable polyester resins are described inter alia in Netherlands Patent Applications 6807896 and 7116891 and European Patent Application 146980. Polyester resins or modified polyester resins which in their polymer chain bear groups with a dipole moment greater than 2 can be obtained by including in the reaction mixture in a suitable quantity, for example, 10 to 50 mol-%, a bifunctional or polyfunctional reagent which bears such polar groups or forms such groups during the polymerization reaction. Thus sulphonyl groups can be incorporated in the polymer chain by adding to the reaction mixture a diol which bears sulphonyl groups, as described in Netherlands Patent Application 7,116,891. Modified polyester resins which bear amide groups in their polymer chain (hereinafter referred to as polyester amides) can be obtained by the standard polycondensation techniques for the preparation of polyesters, the diol in the reaction mixture being partly replaced (for example 10 to 50 mol-%) by a diamine or amino-alcohol.

Examples of suitable diamines and amino-alcohols are tetramethylene diamine, hexamethylene diamine, p-phenylene diamine, 1-amino-2-ethanol, 1-amino-2-propanol and 1-amino-3-propanol.

The coloring material contains at least one dye according to the above formula, wherein the anion X^{⊖} can be varied in order to optimise the solubility or miscibility of the dye in the thermoplastic resin. Generally, the solubility of the dye in the above-mentioned resins can be improved by using the dye in the form of the tetrafluoroborate, borofluoride, perchlorate, hexafluoro-zirconate or ethyl sulphate instead of the form current in the art, as a chloride, fluoride or sulphate.

For a magenta toner powder, the above dye, in order to obtain the correct color shade, can advantageously be combined with a red-violet fluorescent dye such as C.I. Basic Violet 11:1 (C.I. 45174). For a red toner powder, a highly yellow fluorescing dye, a mixture of such dyes or a mixture of such dye with one or more yellow pigments is added to the magenta color formulation. Suitable yellow fluorescent dyes are Macrolex Fluorescent Yellow 10GN (C.I. Solvent Yellow 160:1), Thermoplast f-Gelb 084 (C.I. nr. 59075), Hostasol Gelb 3G (C.I. Solvent Yellow 98), Macrolex Orange R (C.I. Disperse Orange 47) and Maxilon Brilliant Flavine 10GFF (C.I. Basic Yellow 40).

The total quantity of fluorescent dye in toner powder according to the present invention depends on the color gradation and color saturation required. Generally, the best results are already obtained with a relatively low total quantity of coloring material which, calculated on the basis of the quantity of thermoplastic resin, amounts to not more than about 1.5 to 4% by weight. In addition to the thermoplastic resin, coloring constituents and magnetically attractable material, the toner powder according to the present invention can have further additives in order to influence specific properties. Thus white pigment, for example titanium oxide or zinc oxide, can be added in order to mask the dark color of the magnetically attractable material. A metal salt with a diamagnetic anion can be added in order to avoid fluorescence quenching of the fluorescent dye or dyes.

### DETAILED DESCRIPTION OF THE INVENTION

The present invention will now be explained with reference to the following examples.

The values for L* (lightness), C* (chroma) and h (hue) given in these examples for the toner powders are all obtained by measuring a compact toner powder mass in a cuvette. The value L* particularly of the toner powders described hereinafter and already belonging to the prior art may therefore appear lower than the L* value previously indicated in the literature for these toner powders or toner powders which are comparable with respect to composition. All the color values indicated hereinafter were determined in the same way and are therefore satisfactorily comparable with one another. In addition, the results obtained according to the present invention are also visually well perceptible. The color measurements of the toner powders were carried out with the Coloreye 7000A calorimeter made by Gretag Macbeth with the CIE D65 illuminant as a light source. The measurements were carried out on a clean quartz glass cuvette filled with 7 g of toner powder. The cuvette had a diameter of 60 mm and a height of 40 mm (supplied by Minolta).

The reflection spectrum of the toner powder material is measured and then L*, C* and h are calculated therefrom.

The measurements of the Coloreye 7000A are distinguished by good reproducibility and the possibility of carrying out measurements on a relatively thick powder layer so that the color of the powder itself is actually determined and any ambient influences are excluded. The same clean cuvette is of course used for all the color measurements.

### EXAMPLE 1

Example 1 is a comparative example with the best possible formulations with respect to color quality for magenta, red and yellow toner powder without the dye according to the present invention.

All the toner powders (including those according to the present invention described in Examples 2, 3 and 4) are prepared in the same way by mixing a powder mixture of thermoplastic resin, magnetizable material and coloring constituents in an extruder for about 1 hour at 110° C., and processing the extruded material after cooling, by milling and screening, to give toner powder with a particle size of between about 9 and 14 micrometers.

A Magenta toner powder

| | |
|---|---|
| 83.3% by weight | Polyester resin derived |
| | from propoxylated bisphenol A and |
| | adipic acid/isophthalic acid in a 1/3 ratio by weight |
| 15% by weight | Carbonyl iron with a specific weight |
| | per unit area of 0.55 m²/g |
| 1.7% by weight | Basonyl Rot 550 - tetrafluoroborate |
| | (Color Index No. 45174) |
| Color values: | L*: 32.9; C*: 46.1; h: 349.7 |

B Red toner powder

| | |
|---|---|
| 80.6% by weight | Polyester resin derived from |
| | propoxylated bisphenol A and |
| | adipic acid/isophthalic acid in a 1/3 ratio by weight |
| 15% by weight | Carbonyl iron with a specific |
| | weight per unit area of 0.55 m²/g |
| 2.9% by weight | Paliogeen Rood K3580 |
| | (Color Index No. 71137) |
| 0.95% by weight | Basonyl Rot 550 - tetrafluoroborate |
| 0.55% by weight | Macrolex Fluorescent Yellow 10GN |
| | (Color Index: Solvent Yellow 160:1) |
| Color values: | L*: 30.3; C*: 46.8; h: 34.6 |

C Yellow toner powder

| | |
|---|---|
| 94.9% by weight | Polyester resin derived from |
| | propoxylated bisphenol A and |
| | adipic acid/isophthalic acid in a 1/3 ratio by weight |
| 3% by weight | Carbonyl iron with a specific weight |
| | per unit area of 0.55 m²/g |
| 0.6% by weight | Macrolex Fluorescent Yellow 10GN |
| | (Color Index: Solvent Yellow 160:1) |
| 1.5% by weight | Hostasol Gelb 3G |
| | (Color Index: Solvent Yellow 98) |
| Color values: | L*: 62.5; C*: 77.6; h: 92.3 |

### EXAMPLE 2

Magenta toner powder

| | |
|---|---|
| 83.65% by weight | Polyester resin derived from |
| | propoxylated bisphenol A and |
| | adipic acid/isophthalic acid in a 1/3 ratio by weight |
| 15% by weight | Carbonyl iron with a specific weight |
| | per unit area of 0.55 m²/g |
| 0.45% by weight | Basonyl Rot 550 tetrafluoroborate |
| 0.9% by weight | Dye of formula I in the form of the ethyl sulphate |
| Color values: | L*: 38.1; C*: 50.5; h: 359.4 |

### EXAMPLE 3

Red toner powder

| | |
|---|---|
| 82.35% by weight | Polyester resin derived from |
| | propoxylated bisphenol A and |
| | adipic acid/isophthalic acid in a 1/3 ratio by weight |
| 15% by weight | Carbonyl iron with a specific weight |
| | per unit area of 0.55 m²/g |
| 0.45% by weight | Basonyl Rot 550 tetrafluoroborate |
| 0.87% by weight | Formula I dye as ethyl sulphate |
| 0.84% by weight | Macrolex Fluorescent Yellow 10GN |
| 0.49% by weight | Hostasol Gelb 3G |
| Color values: | L*: 37.7; C*: 59.9; h: 41.8 |

### EXAMPLE 4

Yellow toner powder

| | |
|---|---|
| 94.89% by weight | Polyester resin derived from |
| | propoxylated bisphenol A and |
| | adipic acid/isophthalic acid in a 1/3 ratio by weight |
| 3% by weight | Carbonyl iron with a specific weight |
| | per unit area of 0.55 m²/g |
| 0.6% by weight | Macrolex Fluorescent Yellow 10GN |
| 1.49% by weight | Hostasol Gelb 3G |
| 0.02% by weight | Formula I dye as ethyl sulphate |
| Color values: | L*: 68.3; C*: 89.5; h: 88.3 |

### EXAMPLE 5

Toner powders according to the above examples were processed, in the manner described in U.S. Pat. No. 5 202 211, Example 5, by coating with fluorine-doped tin oxide, to give electrically conductive toner powders having a resistance of about 10⁵ ohm.m (measured as described in U.S. Pat. No. 5 202 211). Using these toner powders, colored surfaces were printed in an Océ CPS 700 color printer on receiving paper of type Océ Top Color Paper, CC520, white, 100 g/m².

The color values of the printed color surfaces on the prints were as follows:
Magenta in accordance with example 1: L*=48 C*=66 h=330
Magenta in accordance with example 2: L*=52 C*=68 h=340
Red in accordance with example 1: L*=43 C*=61 h=30
Red in accordance with example 3: L*=50 C*=68 h=37
Yellow in accordance with example 1: L*=81 C*=94 h=93
Yellow in accordance with example 4: L*=84 C*=100 h=91

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A colored magnetically attractable toner powder containing magnetically attractable material and a coloring substance containing a thermoplastic material and coloring constituents, wherein the coloring constituents comprise a mixture of fluorescent dyes, at least one of the fluorescent dyes in said mixture being a dye of the formula: 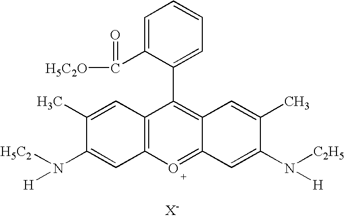
where X is an anion.

2. The toner powder according to claim 1, wherein the anion is a tetrafluoroborate, perchlorate, hexafluorozirconate or ethyl sulphate anion.

3. The toner powder according to claim 1, wherein said mixture contains yellow fluorescent dye.

4. The toner powder according to claim 1, wherein said mixture contains red or magenta fluorescent dye.

5. The toner powder according to claim 4, wherein the dye is C.I. Basic Violet 11:1 (C.I. 45174).
